(19) United States
(12) Patent Application Publication
(10) Pub. No.: US 2010/0275574 A1
(43) Pub. Date: Nov. 4, 2010

(54) BORESCOPE PLUG WITH BRISTLES

(75) Inventor: Anil Salunkhe, Greer, SC (US)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/433,439

(22) Filed: Apr. 30, 2009

(51) Int. Cl. F01D 21/00; F02C 7/00

(52) U.S. Cl. 60/39.091; 415/9

(57) ABSTRACT

In one embodiment, a system includes a rotary machine including a casing, a shaft extending through the casing, and multiple blades coupled to the shaft inside the casing. The system also includes a plug disposed in an opening in the casing, wherein the plug includes a filler coupled to a base, and the filler is configured to break away upon impact with the blades.

### BACKGROUND OF THE INVENTION

The subject matter disclosed herein relates to gas turbine engines, and more specifically, to borescope plugs.

In general, gas turbine engines combust a mixture of compressed air and fuel to produce hot combustion gases. The combustion gases may flow through a turbine to generate power for a load and/or a compressor. The compressor compresses air through a series of stages, each stage having multiple blades rotating about a central shaft. Regular compressor maintenance may involve inserting a borescope into each compressor stage to inspect the compressor blades and other compressor components. The borescope may be inserted through inspection ports positioned along the axial and/or circumferential directions of the compressor during periods when the gas turbine engine is not in operation. To prevent compressed air from leaking through the inspection ports after the borescope has been removed and the gas turbine engine is in use, each port may be sealed with a plug. These plugs may include a filler that substantially extends through the entire length of the inspection port. However, the length of the inspection ports may vary along the longitudinal axis of the compressor. Therefore, if a filler configured for a longer inspection port is placed in a shorter inspection port, the filler may protrude into an interior of the compressor. In such situations, compressor blades may contact the filler, potentially damaging the compressor blades.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a rotary machine including a casing, a shaft extending through the casing, and multiple blades coupled to the shaft inside the casing. The system also includes a plug disposed in an opening in the casing, wherein the plug includes a filler coupled to a base, and the filler is configured to break away upon impact with the blades.

In a second embodiment, a system includes a plug configured to mount in an inspection opening in a rotary machine. The plug includes multiple bristles coupled to a mounting base, and the bristles are configured to break away upon impact with rotary blades in the rotary machine.

In a third embodiment, a system includes a machine including a first component that is movable relative to a second component. The system also includes an inspection plug disposed in an inspection opening in the second component, wherein the inspection plug includes multiple fibers coupled to a base, and the fibers are configured to break away upon impact with the first component.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a turbine system having a monitoring system and borescope to inspect the interior of a compressor in accordance with certain embodiments of the present technique;

FIG. 2 is a cutaway side view of the turbine system, as shown in FIG. 1, in accordance with certain embodiments of the present technique;

FIG. 3 is a cutaway side view of a compressor section taken within line 3-3 of FIG. 2 in accordance with certain embodiments of the present technique;

FIG. 4 is a cutaway side view of a borescope plug taken within line 4-4 of FIG. 3 in accordance with certain embodiments of the present technique;

FIG. 5 is a cutaway side view of a borescope plug taken within line 4-4 of FIG. 3 and having bristles that extend past the end of an inspection port in accordance with certain embodiments of the present technique; and

FIG. 6 is a cutaway side view of a borescope plug taken within line 4-4 of FIG. 3 and having bristles that are shorter than the length of the inspection port in accordance with certain embodiments of the present technique.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure may substantially reduce or eliminate the possibility of compressor blade damage by employing borescope plugs having fillers configured to break away upon impact with compressor blades. In this configuration, if a borescope plug extends within the path of compressor blades, the portion of the filler that contacts the blades may break away. For example, in certain embodiments, the borescope plug may include bristles composed of a material and having a thickness and density such that contact with the compressor blades breaks away a portion of the bristles while substantially reducing or eliminating damage to the compressor blades. The orientation of the bristles may be along a radial, circumferential and/or axial direction, for example. Furthermore, the bristles may serve to absorb acoustical energy that may otherwise induce pressure oscillations within the compressor.

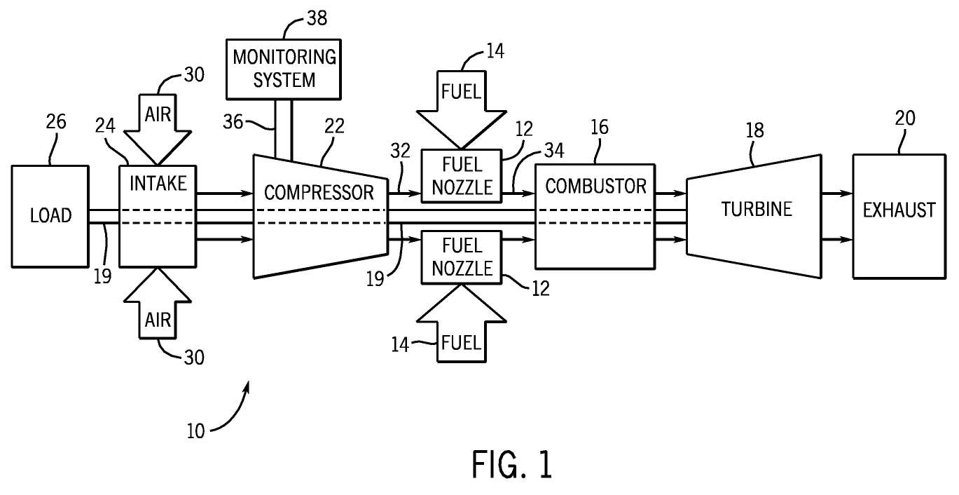

Turning now to the drawings and referring first to FIG. 1, a block diagram of an embodiment of a gas turbine system 10 is illustrated. The diagram includes fuel nozzle 12, fuel supply 14, and combustor 16. As depicted, fuel supply 14 routes a liquid fuel and/or gas fuel, such as natural gas, to the turbine system 10 through fuel nozzle 12 into combustor 16. The combustor 16 ignites and combusts the fuel-air mixture, and then passes hot pressurized exhaust gas into a turbine 18. The exhaust gas passes through turbine blades in the turbine 18, thereby driving the turbine 18 to rotate. The coupling between blades in turbine 18 and a shaft 19 will cause the rotation of shaft 19, which is also coupled to several components throughout the turbine system 10, as illustrated. Eventually, the exhaust of the combustion process may exit the turbine system 10 via exhaust outlet 20.

In an embodiment of turbine system 10, compressor vanes or blades are included as components of compressor 22. Blades within compressor 22 may be coupled to shaft 19, and will rotate as shaft 19 is driven to rotate by turbine 18. Compressor 22 may intake air to turbine system 10 via air intake 24. Further, shaft 19 may be coupled to load 26, which may be powered via rotation of shaft 19. As appreciated, load 26 may be any suitable device that may generate power via the rotational output of turbine system 10, such as a power generation plant or an external mechanical load. For example, load 26 may include an electrical generator, a propeller of an airplane, and so forth. Air intake 24 draws air 30 into turbine system 10 via a suitable mechanism, such as a cold air intake, for subsequent mixture of air 30 with fuel supply 14 via fuel nozzle 12. As will be discussed in detail below, air 30 taken in by turbine system 10 may be fed and compressed into pressurized air by rotating blades within compressor 22. The pressurized air may then be fed into fuel nozzle 12, as shown by arrow 32. Fuel nozzle 12 may then mix the pressurized air and fuel, shown by numeral 34, to produce a suitable mixture ratio for combustion, e.g., a combustion that causes the fuel to more completely burn, so as not to waste fuel or cause excess emissions.

In certain embodiments, the system 10 may include a borescope 36 and a monitoring system 38 to inspect the interior of compressor 22. For example, the borescope 36 may be a rigid scope or a fiberscope. The borescope 36 may be inserted into various portions (e.g., ports) of compressor 22 during periods when turbine system 10 is not in operation. In this manner, compressor blades and other components of compressor 22 may be examined to ensure the compressor 22 is operating properly. Borescope 36 may be optically coupled to the monitoring system 38. The monitoring system 38 may include a light source that illuminates the interior of compressor 22 via borescope 36. In addition, monitoring system 38 may include an optical sensor capable of monitoring, displaying and/or recording images from borescope 36. In certain embodiments, borescope 36 may include an inner core configured to relay images from the interior of compressor 22 to monitoring system 38 and an outer layer configured to transmit light from monitoring system 38 to compressor 22. In this configuration, the interior of compressor 22 may be monitored and analyzed to ensure compressor 22 is operating within established parameters. Further embodiments may employ alternative compressor inspection devices such as a dye penetrant applicator, an ultrasound probe, or an eddy current probe to inspect the interior of compressor 22.

Borescope 36, or other compressor inspection device, may be inserted into compressor 22 via inspection ports or openings positioned throughout compressor 22. For example, compressor 22 may include at least one inspection port per compressor stage. In further embodiments, compressor 22 may include multiple inspection ports disposed about the circumference of each compressor stage. For example, compressor 22 may include 1, 2, 3, 4, 5, 6, 7, 8, or more circumferentially spaced inspection ports for each compressor stage. In further embodiments, compressor 22 may include inspection ports located at both a downstream position and an upstream position relative to each compressor stage for each circumferential position. This configuration may enable inspection of both the leading edge and trailing edge of the compressor blades.

After inspection of the compressor 22 is complete, each inspection port may be sealed to block compressed air from escaping during turbine operation. In certain embodiments, the inspection ports are sealed with borescope plugs that include a mounting base and a filler. The base may include a threaded portion that secures to an outer casing of the compressor 22. In certain embodiments, the filler may include multiple bristles that extend from the base substantially along the entire length of each inspection port. In this configuration, if a borescope plug having excessively long bristles is inserted into an inspection port, the bristles may bend or break away upon contact with the rotating compressor blades. Specifically, because the bristles may be thin and constructed from a softer material than the compressor blades, the compressor blades may shear off the bristles to the extent of contact without substantially damaging the blades. In other words, the bristles may protect the compressor blades from damage if a borescope plug of improper length is inserted within an inspection port. Furthermore, the bristles may serve to dampen acoustical energy that may otherwise induce pressure oscillations within the compressor 22.

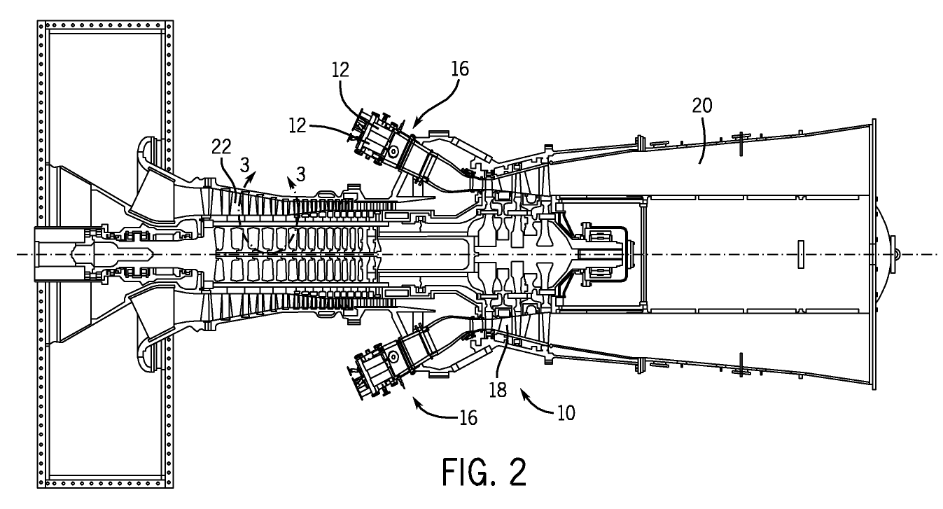

FIG. 2 shows a cutaway side view of an embodiment of turbine system 10. As depicted, the embodiment includes compressor 22, which is coupled to an annular array of combustors 16, e.g., six, eight, ten, or twelve combustors 16. Each combustor 16 includes at least one fuel nozzle 12 (e.g., 1, 2, 3, 4, 5, 6, 7, 8, 9, 10, or more), which feeds an air-fuel mixture to a combustion zone located within each combustor 16. Combustion of the air-fuel mixture within combustors 16 will cause vanes or blades within turbine 18 to rotate as exhaust gas passes toward exhaust outlet 20. As discussed in detail below, certain embodiments of compressor 22 include a variety of unique features to reduce the possibility of damage to compressor blades if a borescope plug of an improper length is inserted into an inspection port.

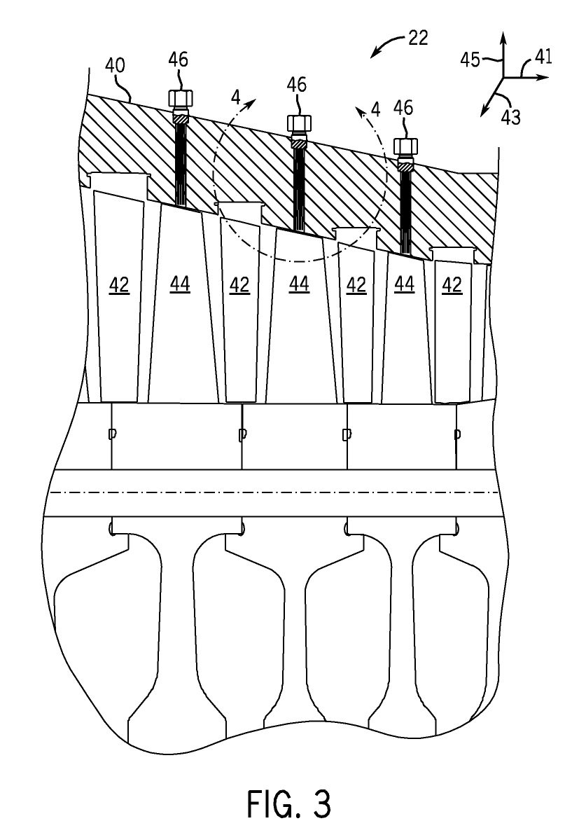

FIG. 3 presents a detailed cross-sectional view of a portion of compressor 22 taken within line 3-3 of FIG. 2. Air enters the compressor 22 along an axial direction 41. The air then passes through one or more compressor stages. Compressor 22 may include 1 to 25, 5 to 20, 10 to 20, or 14 to 18 compressor stages, for example. Each compressor stage includes vanes 42 and blades 44 substantially equally spaced in a circumferential direction 43 about compressor 22. The vanes 42 are rigidly mounted to compressor 22 and configured to direct air toward blades 44. The blades 44 are driven to rotate by shaft 19. As air passes through each compressor stage, air pressure increases, thereby providing combustor 16 with sufficient air for proper combustion.

As previously discussed, compressor 22 may include multiple inspection ports disposed within a casing 40 for monitoring the interior of compressor 22 while turbine system 10 is not in operation. To prevent air from escaping through these ports when the turbine system 10 is in use, the compressor 22 may include multiple borescope plugs 46 configured to seal the inspection ports. As discussed in detail below, each of these borescope plugs 46 may include bristles that extend substantially along the entire length of the inspection port. This configuration may absorb acoustical energy that may otherwise induce pressure oscillations within the compressor 22. Furthermore, the bristles may serve to protect turbine blades 44 from incidental contact with the bristles. Specifically, the bristles may be configured to bend or break away upon impact with the turbine blades 44. In this manner, turbine blades 44 may be protected from accidental insertion of a borescope plug 46 having bristles that are too long for the inspection port.

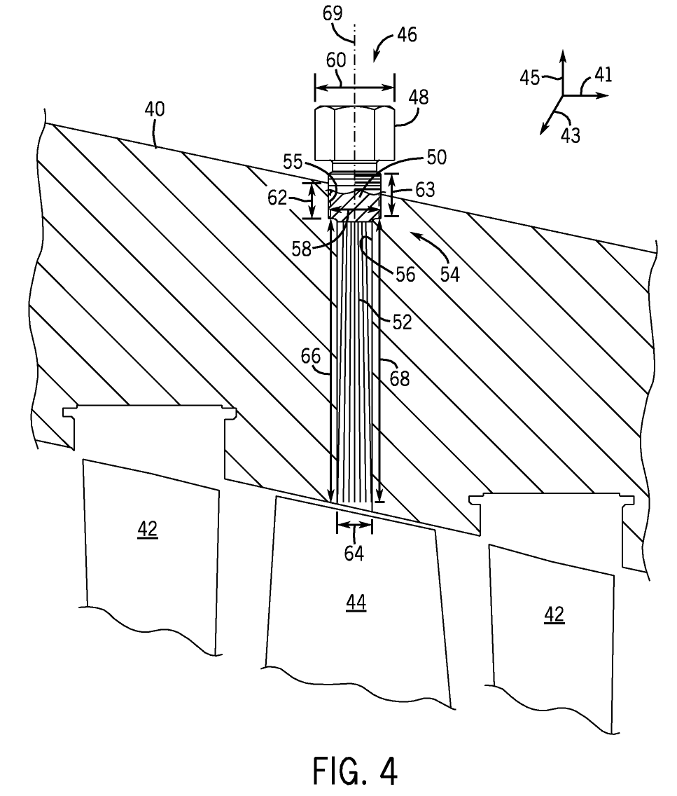

FIG. 4 is a cutaway side view of a borescope plug 46 taken within line 4-4 of FIG. 3. As illustrated, the borescope plug 46 includes a head 48, a seal 50 and bristles 52. The borescope plug 46 is positioned within an inspection port 54 to block compressed air from escaping during compressor operation. The seal 50 is configured to fit within a first aperture 55 of the inspection port 54, while bristles 52 are configured to extend along a second aperture 56. A diameter 58 of the seal 50 is substantially similar to a diameter 60 of the first aperture 55. In this configuration, a tight seal may be formed to block high pressure air from escaping from compressor 22 during turbine system operation. In certain embodiments, the seal 50 includes threads and the first aperture 55 includes complementary tapped grooves (i.e., mating threads) such that borescope plug 46 may be secured to compressor casing 40 via rotation of the head 48. In such an arrangement, head 48 may include a hex-pattern to enable the borescope plug 46 to be secured with a wrench, for example. Furthermore, a length 62 of the first aperture 55 may be greater than a length 63 of the seal 50 to facilitate proper contact between the two components.

A length 66 of the second aperture 56 may be substantially similar to a length 68 of bristles 52. In such a configuration, the bristles 52 may substantially reduce or prevent pressure oscillations from forming within the second aperture 56. Furthermore, the bristles 52 may be arranged to fit within a diameter 64 of the second aperture 56. As discussed in detail below, if the bristles 52 extend within the path of the compressor blades 44, the configuration of the bristles 52 may enable the blades 44 to bend or break away the bristles 52, thereby reducing the possibility of blade damage. Conversely, if the length of the bristles 52 is shorter than the length 66 of the second aperture 56, the bristles 52 may absorb acoustical energy to limit pressure oscillations within the compressor 22.

As illustrated, the bristles 52 are oriented substantially parallel to a threading axis 69 of the seal 50. Alternative embodiments may include bristles oriented in a substantially perpendicular direction to the threading axis 69 (e.g., along the axial direction 41 or the circumferential direction 43). Other embodiments may include bristles 52 angled at more than approximately 1°, 10°, 20°, 30°, 40°, 50°, 60°, 70°, 80°, or more relative to the threading axis 69 toward the radial direction 45, the axial direction 41 and/or the circumferential direction 43. Further embodiments may include bristles 52 oriented in a combination of the above directions. For example, certain embodiments may include a first set of bristles oriented substantially parallel to the threading axis 69 (e.g., along the radial direction 45) and a second set of bristles oriented at approximately 0° to 90°, 20° to 70°, 30° to 60°, or about 45° toward an axial direction 41 and/or a circumferential direction 43 relative to the first set of bristles. In certain embodiments, bristles 52 may be arranged in a random orientation (e.g., steel wool, mineral wool, chopped strand mat, etc.). Other embodiments may include bristles 52 arranged in an interwoven mesh configuration. Yet further embodiments may include bristles 52 bonded together with a resin to form a composite structure.

Alternative embodiments may employ a metal foam filler instead of the bristles 52. A metal foam is a solid metallic structure having multiple gas-filled pores. The density and size of the pores may be particularly configured to provide a structure that both substantially reduces or prevents pressure oscillations from forming within the inspection port 54, and substantially reduces or prevents compressor blade damage if contact occurs. In another embodiment, the filler may be composed of an abradable or frangible material such as metallic particles suspended in a binder. Frangible materials tend to break up into fragments instead of deforming under pressure. Therefore, if a compressor blade 44 impacts the frangible material, the force of the impact may cause the metallic particles to separate from the binder at the point of impact. Therefore, the portion of the filler in contact with the compressor blade 44 may break away from the remainder of the filler and decompose into metallic particles.

As illustrated, the inspection port 54 and the borescope plug 46 are oriented substantially in the radial direction 45. In alternative embodiments, the inspection port 54 may be rotated toward the circumferential direction 43 and/or the axial direction 41. For example, the inspection port 54 may be rotated toward the circumferential direction 43 away from the direction of rotation of the compressor blades 44. In other words, an axis of the plug 46 may be directed toward but offset from a rotation axis of the shaft 19. This configuration may facilitate enhanced deformation and/or breaking away of the bristles 52 upon contact with the compressor blades 44. For example, the inspection port 54 may be rotated at least 1°, 2°, 5°, 8°, 10°, 15°, 20°, 30°, 45°, or more about the axial direction 41 toward the circumferential direction 43.

The bristles 52 may be composed of a variety of materials. For example, in certain embodiments, the bristles 52 may be composed of metal such as steel, aluminum, copper, titanium, or tungsten, among other metals and alloys. In alternative embodiments, bristles 52 may be composed of ceramic fibers containing oxides of aluminum, silicon and/or boron, among others. Further embodiments may include bristles 52 composed of glass and/or carbon fibers. Yet further embodiments may include bristles 52 composed of a cermet, such as tungsten carbide. Other embodiments may include bristles 52 composed of plastic/synthetic fibers such as para-aramid (e.g., Kevlar®, available from DuPont), meta-aramid (e.g., Nomex®, available from DuPont), acrylic, or polyethylene, for example.

The composition of the bristles 52 may be selected based on the material properties of the constituent fibers. Specifically, bristles 52 may be selected such that their melting temperature is greater than the maximum air temperature the bristles 52 may experience during compressor operation. For example, as air is compressed within compressor 22, air temperature increases. Therefore, temperature within the later stages of compressor 22 may be greater than the temperature of the earlier stages. In certain embodiments, compressor temperature may range from approximately 100 to 1200 degrees, 100 to 900 degrees, or 200 to 800 degrees, for example. As a result, bristles 52 may be selected based on the maximum anticipated exposure temperature. In certain embodiments, bristle material may vary based on compressor stage. For example, earlier compressor stages may employ fibers with lower melting points, while later compressor stages employ fibers with higher melting points. Therefore, bristles 52 may be selected based on the melting temperature of the constituent fibers and the position of the bristles 52 within compressor 22. However, to prevent bristle damage from accidentally inserting a borescope plug 52 having low melting point fibers into a later compressor stage having a higher temperature than the fiber melting point, all bristles 52 may be selected such that the melting point of the fibers is greater than the maximum compressor temperature.

The density and thickness of the bristles 52 may also vary in certain embodiments. For example, each bristle 52 may be approximately 1 to 15, 2 to 10, or 4 to 6 mils thick. In certain embodiments, each bristle 52 may be less than approximately 1, 2, 3, 4, 5, 6, 8, 10, 12, or 15 mils thick, for example. In addition, the density of bristles may be approximately 10 to 2500, 100 to 1500, 200 to 1000, or 300 to 500 bristles per square inch. In certain embodiments, the bristle density may be less than approximately 10, 25, 50, 100, 150, 300, 500, 800, 1000, 1200, 1500, 2000, or 2500 bristles per square inch. In further embodiments, the distribution of the bristles 52 may not be uniform. For example, the bristles 52 may be grouped in packets across the seal 50. The bristle thickness and density may be directly related to the composition of the bristles. For example, thinner and lower density configurations may employ harder materials (e.g., metal or ceramic fibers), while thicker and higher density configurations may employ softer materials (e.g., plastic or synthetic fibers). Such configurations may serve to protect compressor blades 44 from damage due to accidental contact with bristles 52. In addition, as discussed below, bristle thickness and density may be selected to substantially reduce or eliminate pressure oscillations within compressor 22.

The bristles 52 may serve to limit the formation of pressure oscillations within compressor 22. Specifically, as air flows through the compressor 22, air may enter the second apertures 56. The second apertures 56 may serve as acoustical resonators, inducing pressure oscillations that may cause undesirable compressor blade vibrations. The bristles 52 may block airflow into the second apertures 56, thereby reducing resonance and decreasing the magnitude of pressure oscillations. In addition, pressure oscillations may be induced by vortex shedding from the interface between the second apertures 56 and the interior of compressor 22. The bristles 52 may interfere with the airflow pattern that creates these vortices such that vortex shedding and the resultant pressure oscillations are reduced. Finally, the bristles 52 may serve to absorb acoustical energy from air entering the second apertures 56 between the bristles 52, thereby further reducing pressure oscillations within the compressor 22. Reduction of pressure oscillations may increase compressor efficiency by reducing compressor blade vibration.

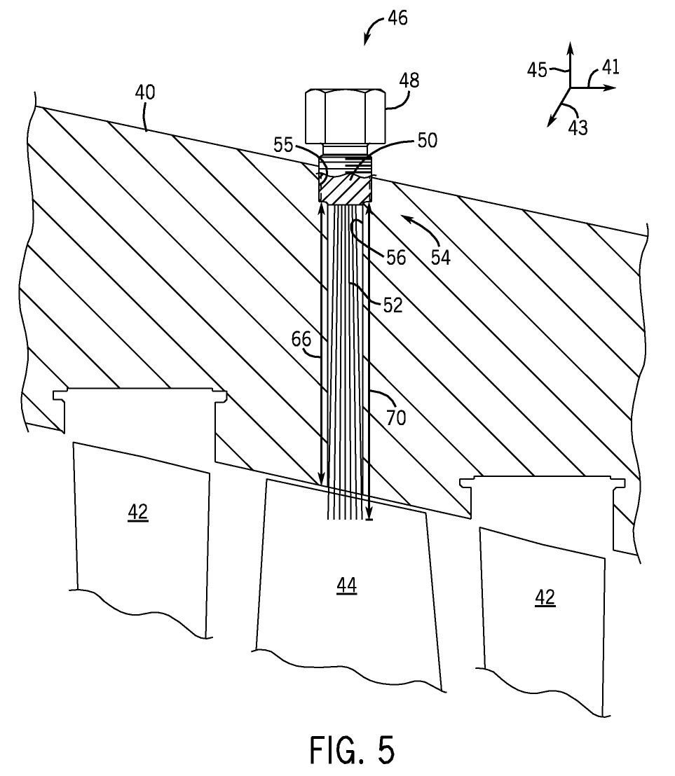

FIG. 5 is a cutaway side view of a borescope plug 46 taken within line 4-4 of FIG. 3 in which the bristles 52 extend into the rotational path of compressor blades 44. For example, if a borescope plug 46 having bristles 52 of length 70 is inserted within an inspection port 54 having a second aperture 56 of length 66, the bristles 52 may extend past the inner radial extent of the second aperture 56. Such an arrangement may result from accidentally inserting a borescope plug 46 configured to fit within a second aperture 56 of length 70 into a second aperture 56 of length 66. In such a situation, the bristles 52 may be configured to deform and/or break away such that the possibility of damage to the compressor blades 44 is substantially reduced or eliminated. For example, as previously discussed, the composition, thickness and/or density of the bristles 52 may enable a portion of the bristles 52 that extends within the path of compressor blades 44 to break away upon contact with the compressor blades 44. Alternatively, contact between the compressor blades 44 and the bristles 52 may cause the bristles 52 to temporarily or permanently deform such that the possibility of damage to the blades 44 is substantially reduced or eliminated.

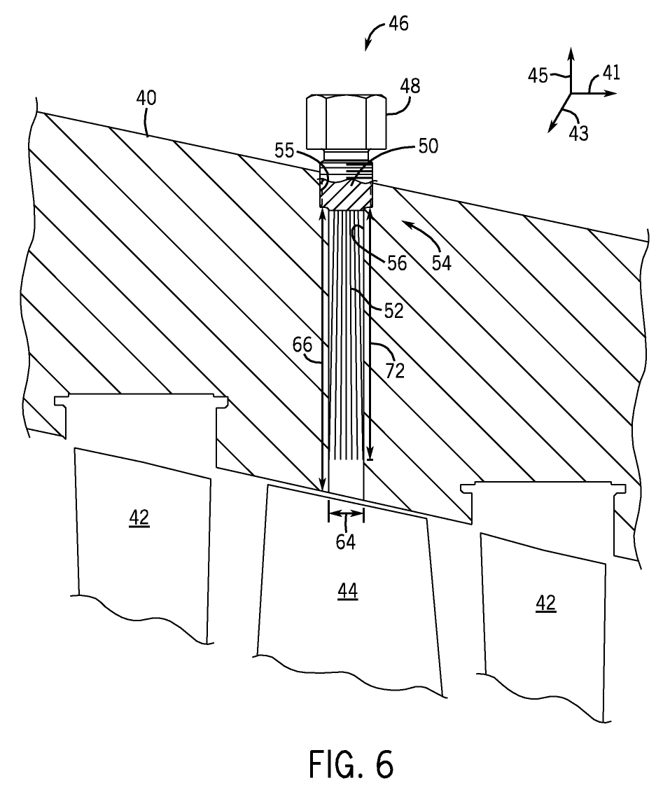

FIG. 6 is a cutaway side view of a borescope plug 46 taken within line 4-4 of FIG. 3 in which the bristles 52 do not extend along the entire radial extent of the second aperture 56. For example, if a borescope plug 46 having bristles 52 of length 72 is inserted within an inspection port 54 having a second aperture 56 of length 66, the bristles 52 may not extend along the entire radial extent of the second aperture 56. Such an arrangement may result from accidentally inserting a borescope plug 46 configured to fit within a second aperture 56 of length 72 into a second aperture 56 of length 66. In such a situation, a portion of the second aperture 56 may form a cavity along the path of air flowing through the compressor 22. However, such a cavity may not significantly contribute to pressure oscillations within the compressor 22. Specifically, experimentation has determined that cavity depths less than a fraction of the diameter 64 may not establish a pressure oscillation within compressor 22. For example, if the cavity depth is less than approximately 10%, 25%, 50%, 75%, or 100% of the diameter 64 of the second aperture 56, pressure oscillations may not form. In addition, as previously discussed, the bristles 52 may absorb acoustical energy such that pressure oscillations are substantially reduced or eliminated. For example, as air enters the spaces between bristles 52, the bristles 52 may dampen the acoustical energy and reduce pressure oscillations.

As appreciated, the borescope plug 46 with bristles 52 may be employed for other machine configurations in alternative embodiments. For example, in addition to the compressor 22 described above, borescope plugs 46 of this configuration may be employed in various other types of rotating machines, such as a turbine 18. In addition, the borescope plug 46 with bristles 52 may be employed on any rotating machine in which a rotating part may contact a plug 46, thereby substantially reducing or eliminating the possibility of damage to the rotating part. In addition, this plug design may be utilized for sealing other types of openings within a rotating machine, in addition to inspection ports 54.

Furthermore, borescope plugs 46 with bristles 52 may be employed on machines having linearly moving parts. For example, if an inspection port, or other opening, within a surface of a linear machine is sealed within a plug 46 having bristles 52, the possibility of damage to moving parts within the machine may be substantially reduced or eliminated if contact is made with the plug 46. For example, if a piston is moving within a cylinder of a linear machine and a borescope plug 46 extends within the path of the piston, the piston may contact the bristles 52 causing the bristles to break away and/or deform. This arrangement may substantially reduce or eliminate the possibility of damage to the piston. Similarly, the borescope plug 46 with bristles 52 may be employed in other machine configurations (linear, rotating, etc.) to reduce the possibility of damage to moving parts if the moving parts contact the borescope plug 46.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a rotary machine, comprising:
a casing;
a shaft extending through the casing;
a plurality of blades coupled to the shaft inside the casing; and
a plug disposed in an opening in the casing, wherein the plug comprises a filler coupled to a base, and the filler is configured to break away upon impact with at least one of the plurality of blades.

2. The system of claim 1, wherein the filler comprises a plurality of bristles.

3. The system of claim 2, wherein the plurality of bristles have a diameter less than approximately 15 mils and a packing density of less than approximately 2500 bristles per square inch.

4. The system of claim 2, wherein the plurality of bristles are arranged along an axis of the opening in a generally radial direction relative to a rotational axis of the shaft.

5. The system of claim 2, wherein the plurality of bristles comprise a metal, a ceramic, a cermet, a plastic, or a combination thereof.

6. The system of claim 1, wherein the opening has a plug axis directed toward but offset from a rotation axis of the shaft.

7. The system of claim 1, wherein the filler comprises a plurality of fibers in a radial direction, an axial direction, a circumferential direction, or a combination thereof, relative to a rotation axis of the shaft.

8. The system of claim 1, wherein the rotary machine comprises a compressor, a turbine, or a combination thereof, having the plurality of blades.

9. The system of claim 1, wherein the plug is removable to enable insertion of an inspection device into the rotary machine to inspect the plurality of blades.

10. A system, comprising:
a plug configured to mount in an inspection opening in a rotary machine, wherein the plug comprises a plurality of bristles coupled to a mounting base, and the bristles are configured to break away upon impact with at least one rotary blade in the rotary machine.

11. The system of claim 10, wherein the plurality of bristles have a diameter of approximately 1 to 15 mils and a packing density of approximately 10 to 2500 bristles per square inch.

12. The system of claim 10, wherein the mounting base comprises threads disposed about a plug axis, and the plurality of bristles are arranged along the plug axis.

13. The system of claim 10, wherein the plurality of bristles comprise a metal, a ceramic, a cermet, a plastic, or a combination thereof, having a melting temperature of at least greater than approximately 500 degrees Fahrenheit.

14. The system of claim 10, wherein the plurality of bristles comprise para-aramid fibers.

15. The system of claim 10, wherein the plug is a borescope plug, the inspection opening is a borescope opening, and the plug is removable to enable insertion of a borescope into the rotary machine to inspect the rotary blades.

16. A system, comprising:
a machine comprising a first component that is movable relative to a second component; and
an inspection plug disposed in an inspection opening in the second component, wherein the inspection plug comprises a plurality of fibers coupled to a base, and the plurality of fibers are configured to break away upon impact with the first component.

17. The system of claim 16, wherein the machine comprises a compressor, a turbine, or a combination thereof, the first component comprises a plurality of blades, and the second component comprises a casing.

18. The system of claim 16, comprising a monitoring system having a probe configured to extend into the inspection opening with the inspection plug removed from the inspection opening.

19. The system of claim 16, wherein the base comprises a threaded steel base having a threading axis, the plurality of fibers are arranged in parallel to the threading axis, the plurality of fibers have a diameter of approximately 1 to 15 mils, the plurality of fibers have a packing density of approximately 10 to 2500 fibers per square inch, and the plurality of fibers have a melting temperature of approximately 100 to 1200 degrees Fahrenheit.

20. The system of claim 16, wherein the plurality of fibers dampen acoustical energy in the inspection opening.
